(19) United States
(12) Patent Application Publication
(10) Pub. No.: US 2026/0143207 A1
(43) Pub. Date: May 21, 2026

(54) Smart Content Caller

(71) Applicant: DISH Network Technologies India Private Limited, Bangalore (IN)

(72) Inventors: Visali Manoharan, Vanagaram (IN); Vikram Balarajashetty, Bangalore (IN); Dileep Puramana, Wandoor (IN); Manasa Jami, Madhurawada (IN)

(73) Assignee: DISH Network Technologies India Private Limited, Bangalore (IN)

(21) Appl. No.: 18/954,789

(22) Filed: Nov. 21, 2024

(51) Int. Cl. H04N 21/84; H04N 21/235

(52) U.S. Cl. CPC H04N 21/84; H04N 21/2353

(57) ABSTRACT

Devices, systems, computer readable mediums, and processes for identifying related content for a current episode in a prior episode is described. For an implementation, a user device executes computer instructions which instantiate a smart content access engine (SCAE) that configures the user device to: identify prior episode content (PEC) that relates to a given current episode content (CEC). The user device retrieves and presents PEC which relates to a CEC. The PEC is selected based upon determined relations between prior aspect information for the PEC that relates to current aspect information in the CEC. The current aspect may include a character, scene or other aspect of the CEC. The PEC, for the related content, may be identified by a link embedded with the CEC in an expanded content data. Upon selecting the link, the related PEC may be presented in a side-bar, overlay or other user interface.

### TECHNICAL FIELD

The technology described herein generally relates to devices, systems, and processes by which facilitate an identification of and a providing, a given user, with access to prior episode content that relates to one more aspects of a current episode content.

### BACKGROUND

A given user may watch, at a current time, a given episode (out of many episodes) of a digital content series. The given episode is herein referred to as the “current episode” when so presented to the given user at the current time. During the presentation of the current episode one or more instances of content in the current episode may be presented to the given user-such content is referred to herein as the “current episode content (CEC).” The current episode content may refer, relate, be informative of, or otherwise be associated with (herein “relate”) one more instances of a given content that was provided in one or more prior episodes of the digital content series—such given content is referred to herein as the “prior episode content (PEC).” The prior episode content may contain information that may inform and/or assist the given user in understanding the current episode content. The given user may not have received a presentation of the one or more prior episodes in which the prior episode content was presented and/or the given user may have received such content presentation(s) but forgotten, or otherwise could benefit from a refreshing of one's memory with various aspects of the prior episode content previously presented during the presentation of one or more prior episodes in the digital content series. Herein an “aspect” of the digital content presented in one or more scenes, portions, episodes or the like of a digital content series may include, without limitation, information regarding a setting, scene, historical basis, character, character relationship, character development, past actions (or inactions) occurring in the digital content series, and/or other information-such information is herein referred to as “aspect information.”

For a non-limiting example, STAR WARS™ is a digital content series that includes multiple episodes. During the episodes various characters are introduced and their history and development over time is presented. For example, DARTH VADER™ and LUKE SKYWALKER™ were first presented to a user in the 1970s. Yet, the father-son relationship of DARTH VADER and LUKE SKYWALKER was not presented until episode 7. As any fan of the Star Wars series may appreciate, episodes of the series were originally presented in a non-chronological order, with episodes 4-6 being first presented (e.g., originally theatrically released) in the 1970s and 1980s, episodes 1-3 being first presented in the 1990s and early 2000s, and episodes 7-9 being first presented in the late 2010s. Given these extended and non-chronological episode releases, a given user first viewing a given episode may benefit from receiving aspect information, regarding LUKE and/or DARTH VADER, which was previously presented during one or more of the prior episodes of the given digital content series and/or from another digital content and/or digital content series.

Presently no devices, systems, methods or the like are known which enable a given user to receive aspect information from a prior episode content that relates to a current episode content.

Accordingly, devices, systems, methods and computer executable instructions are needed which facilitate an identification of available prior episode content to a given user and provides the given user with access to the prior episode content that relates to one more aspects of a current episode content.

### SUMMARY

Various implementations are described of devices, systems, and processes by which, with respect to a given user, identification of available prior episode content to a given user and provides the given user with access to the prior episode content that relates to one more aspects of a current episode content.

In accordance with at least one implementation of the present disclosure, a system of one or more computers can be configured to perform particular operations or actions by virtue of having software, firmware, hardware, or a combination thereof installed on the system that, in operation, cause(s) the system to perform the actions. One or more computer programs can be configured to perform particular operations or actions by virtue of including instructions that, when executed by a data processing apparatus, cause the apparatus to perform the actions.

For at least one implementation of the present disclosure, a user device may include a user device data store (UDDS) which transitorily stores first computer instructions which, when executed, instantiate a smart content access engine (SCAE). The user device may also include a user device processor (UDP) coupled to the UDDS and a user interface coupled to the UDP and an input/output (I/O) device. The UDP, when executing the first computer instructions, may instantiate the SCAE which configures the user device to perform smart content access operations (SCAO) including identifying, to a user of the user device, prior episode content (PEC) that relates to a given current episode content (CEC). The CEC may be provided in a current episode of a digital content series by a content source. The digital content series may include the current episode and a prior episode. The PEC may be provided in the prior episode. The SCAO may also include receiving a user request for a presentation of the PEC, retrieving the PEC from a content source coupled to the user device; and presenting the PEC to the user via the I/O device.

For at least one implementation of the user device, the UDDS may non-transitorily further store second computer instructions which, when executed by the UDP, instantiate a current episode content module (CECM) which configures the user device to perform current episode content recognition operation (CECRO). The CECRO may include retrieving the CEC from the content source. The CEC may include two or more current episode content portions (CECP). The CECRO may further include storing the CECP in the UDDS as current episode content data (CECD), identifying in one of the CECPs, current aspect information (CAI) for a current aspect presented in the CECP, and storing the CAI in the UDDS.

For at least one implementation of the user device, the CAI may identify at least one aspect of the CEC presented in the CECP. The at least one aspect may be a character occurring in the current episode.

For at least one implementation of the user device, the UDDS may non-transitorily further store third computer instructions which, when executed by the UDP, instantiate a prior episode content module (PECM) which configures the user device to perform prior episode content recognition operation (PECRO) including searching the content source to identify PEC which include prior presentations of the current aspect, storing, in the UDDS, at least one result arising from the searching as prior episode content data (PECD), identifying in the PEC, prior aspect information (PAI) that relates to the CAI for the current aspect presented in the CECP, and storing the PAI in the UDDS.

For at least one implementation of the user device, the UDDS may non-transitorily further store fourth computer instructions which, when executed by the UDP, instantiate a content linking module (CLM) which configures the user device to perform content linking operations (CLO) including comparing the CAI to the PAI to identify relations between the CAI and the PAI, generating, based on a result of the comparing, related content link data (RCLD) for the PAI that has been identified as being related to the CAI, and storing the PAI in the UDDS.

For at least one implementation of the user device, the UDDS may non-transitorily further store fifth computer instructions which, when executed by the UDP, instantiate a content expansion module (CEM) which configures the user device to perform content expansion operations (CEO) including retrieving the CECD from the UDDS, retrieving the RCLD from the UDDS, generating expanded content data (ECD) by embedding, in the CECD, a link to the PECD identified in the RCLD, and storing the ECD in the UDDS.

For at least one implementation of the user device, the link in the ECD may be selectable by the user during a presentation of the ECD to the user and, wherein upon selection of the link, a presentation of the CECD may include a presentation of the PECD identified in the RCLD.

For at least one implementation of the user device, during the presentation of the PECD, the presentation of the CECD may be temporarily suspended until the presentation of the PECD ends.

For at least one implementation of the present disclosure, a computer readable medium non-transitorily storing computer instructions which, when executed by a processor, instantiate a smart content access engine (SCAE) which configures a user device to perform operations including identifying, to a user of the user device, prior episode content (PEC) that relates to a given current episode content (CEC). The CEC may be provided in a current episode of a digital content series provided by a content source. The digital content series may include the current episode and a prior episode. The PEC may be provided in the prior episode. The operations may further include retrieving the CEC from the content source. The CEC may include two or more current episode content portions (CECP). The operations may further include: identifying in one of the CECPs, current aspect information (CAI) for a current aspect presented in the CECP, searching the content source to identify PEC which include prior presentations of the current aspect, identifying in the PEC, prior aspect information (PAI) that relates to the CAI for the current aspect presented in the CECP, comparing the CAI to the PAI to identify relations between the CAI and the PAI, generating, based on a result of the comparing, related content link data (RCLD) for the PAI that has been identified as being related to the CAI, generating expanded content data (ECD) by embedding, in the CEC, a link to the PAI identified in the RCLD, and storing the ECD.

For at least one implementation of the computer readable medium, the link in the ECD may be selectable by the user during a presentation of the ECD to the user and, upon selection of the link, a presentation of the CEC may include a presentation of the PEC identified in the RCLD.

For at least one implementation of the computer readable medium, during the presentation of the ECD, the presentation of the CEC may occur in a first presentation window and the PEC identified in the RCLD occurs in a sidebar presentation window. The operations may occur automatically.

For at least one implementation of the present disclosure, a process computer for training an artificial intelligence/machine learning (AI/ML) configured server episode relations engine (SERE) to identify at least one relationship between a current episode content (CEC) and a prior episode content (PEC), wherein the CEC and the PEC are each an episode of a digital content series provided by a content source, may include identifying, from “X” instances of digital content provided in “Y” episodes of the digital content series, “Z” portions of digital content, wherein X, Y and Z are integers. The process may further include: generating an initial data set populated by related data obtained for two or more of the Z portions of digital content; and applying a linear regression analysis to the related data in the initial data set to generate a first reduced data set. The linear regression analysis may identify, based on the related data, relations between content provided for each of a first portion of the Z portions of digital content with content provided in each of the other portions of the Z portions of the digital content. The process may further include generating related content link data (RCLD) based on results obtained from the linear regression analysis. The RCLD, when embedded into expanded content data (ECD), may include a first instance of the X instances of the digital content series and a link to a second portion of the X instances of the digital content series.

For at least one implementation of the process, the related data may be obtained from the content source. The related data includes at least one of metadata and audio data.

For at least one implementation the process may include applying a polynomial regression analysis to the related data in the initial data set to generate a second reduced data set. The polynomial regression analysis may further identify, based on the related data, relations between content provided for each of a first portion of the Z portions of digital content with content provided in each of the other portions of the Z portions of the digital content. The generating of the related content link data may be further based on results obtained from the polynomial regression analysis.

For at least one implementation, the process may include receiving user feedback. The user feedback concerns a utilization of the RCLD, as presented to a user of a user device configured to receive and present the ECD to the user. The process may include: identifying a portion of the Z portions of digital content to which the user feedback pertains; identifying the RCLD presented to the user with respect to which the user feedback pertains; determining if the user feedback is a LIKED; and when the user feedback is LIKED, increasing a weighting of the RCLD with respect to the portion of the Z portions of digital content.

For at least one implementation, the process may include determining if the user feedback is a DISLIKED and, when the user feedback is DISLIKED, decreasing the weighting of the RCLD with respect to the portion of the Z portions of digital content.

For at least one implementation, the process may include performing a regression analysis on the user feedback to determine if the user feedback is LIKED or DISLIKED.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of various implementations of the present disclosure is provided in the following written description and illustrated in the accompanying drawings.

### BRIEF DESCRIPTION OF THE DRAWINGS

The features, aspects, advantages, functions, modules, and components of the devices, systems, and processes provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference label irrespective of any additional alphabetic designators or second reference labels, if any.

FIG. 1 is a schematic illustration of an implementation of a smart content access system (SCAS) and in accordance with at least one implementation of the present disclosure.

FIG. 2 illustrates a process by which a smart content access engine (SCAE), as instantiated by a processor in a user device, performs one or more smart content access operations (UDSCAO), and in accordance with at least one implementation of the system described in the present disclosure.

FIGS. 3A-3B illustrate a process by which a server episode relations engine (SERE), instantiated by a server processor that is utilizing Artificial Intelligence and Machine Learning, performs one or more server content recognition operations and in accordance with at least one implementation of the system described in the present disclosure.

### DETAILED DESCRIPTION

Various implementations of the present disclosure describe devices, systems, and processes which identify available prior episode content, to a given user, and provides the given user with access to the prior episode content that relates to one more aspects of a current episode content.

“Additional I/O interface” (AIOI) herein refers to one or more components, provided with or coupled to a device, configured to support a receiving and/or presenting of additional inputs and outputs to and from one or more users. An AIOI may be configured to support the receiving and presenting of the additional I/O content (AIO) to users. Herein, the AIO, as communicated, may be referred to as “AIO signals.” An AIO signal may include an audible signal or a visible signal and may be communicated separately or collectively therewith. An AIOI may include any interface not otherwise categorized as an Audio I/O interface or a Visual I/O interface with non-limiting examples including touch pads, keyboards, sensors, motion detectors, tactile elements, and the like. Any known or later arising technologies configured to convey information to or from one or more users as an AIO signal may be utilized for at least one implementation of the present disclosure. An AIOI includes hardware and computer instructions (herein, “AIO technologies”) which supports the input and output of other signals with a user.

“Application” (which are also commonly referred to as a “computer program”) herein refers to a set of computer instructions that configure one or more processors to perform one or more tasks that are other than tasks commonly associated with the operation of the processor itself (e.g., a “system software,” an example being an operating system software), or the providing of one or more utilities provided by a device (e.g., a “utility software,” an example being a print utility). An application may be bundled with a given device or published separately. Non-limiting examples of applications include word processing applications (e.g., Microsoft WORD™), video streaming applications (e.g., SLINGTV™), video conferencing applications (e.g., ZOOM™), gaming applications (e.g., FORTNITE™), and the like. For at least one implementation, an application may be configured as, include, and/or utilize a “plug-in” (as described below).

“AI/ML” (Artificial Intelligence/Machine Learning) herein refers to the use of one or more supervised learning, unsupervised learning, and/or refinement learning processes (as executed by one or more processors which may include processors associated with one or more neural networks) to perform one or more of the operations of the various computer engines described herein.

“Audio I/O interface” herein refers to one or more components, provided with or coupled to an electronic device, configured to support a receiving and/or presenting of humanly perceptible audible content to one or more users. Such audible content (which is also referred to herein as being “audible signals”) may include spoken text, sounds, or any other audible information. Such audible signals may include one or more humanly perceptible audio signals, where humanly perceptible audio signals typically arise between 20 Hz and 20 KHz. The range of humanly perceptible audio signals may be configurable to support an audible range of a given individual user. An audio I/O interface includes hardware and computer instructions (herein, “audio technologies”) which supports the input and output of audible signals to a user. Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise. An audio I/O interface may use one or more microphones and speakers to capture and present audible signals respectively from and to a user. Such one or more microphones and speakers may be provided by a given device itself or by a device communicatively couple additional audible device component. For example, earbuds may be communicatively coupled to a smartphone, with the earbuds functioning as an audio I/O interface and capturing and presenting audio signals as sound waves to and from a user, while the smartphone functions as a UD. An audio I/O interface may be configured to automatically recognize, and capture comments spoken by a user and intended as audible signals for sharing with other users, inputting commands, or otherwise.

“Bus” herein refers to any known and/or later arising technologies which facilitate the transfer of data within and/or between components of a device. Non-limiting examples include Universal Serial Bus (USB), PCI-Express, Compute Express Link (CXL), IEEE-488 bus, High Performance Parallel Interface (HIPPI), and the like.

“Cloud” herein refers to cloud computing, cloud storage, cloud communications, and/or other technology resources which a given user does not actively manage or provide. A usage of a Cloud resource may be private (limited to various users and/or uses), public (available for multiple users and/or uses), hybrid, dedicated, non-dedicated, or otherwise. An implementation may utilize Cloud resources using any known or later arising data delivery, processing, storage, virtualization, or otherwise technologies, standards, protocols (e.g., the Simple Object Access Protocol (SOAP), the Hyper Text Transfer Protocol (HTTP), Representational State Transfer protocol (REST), or the like. Non-limiting examples of such technologies include Software as a Service (SaaS), Platform as a Service (Paas), Infrastructure as a Service (Iaas), and the like. Cloud resources may be provided by one or more entities, such as AMAZON WEB SERVICES provided by Amazom.com Inc., AZURE provided by Microsoft Corp., and others.

“Component” herein refers to a Module of a Device, as further defined herein.

“Computer Data” herein refers to Data, as further defined herein.

“Computer engine” (or “engine”) herein refers to a combination of a processor and computer instruction(s). A computer engine executes computer instructions to perform one or more logical operations (herein, a “logic”) which facilitate various actual (non-logical) and tangible features and function provided by a system, a device, and/or combinations thereof.

“Computer instruction” herein refers to an Instruction, as further defined herein.

“Communications Interface” herein refers to one or more separately provided components and/or integrated with other components of a Device that is configured to facilitate communication of data with one or more other devices using a Coupling. Non-limiting examples of communications interfaces including networking cards, Wi-Fi™ modules, Ethernet ports, Bluetooth radio modules, wireless radio modules, and the like. Any known or later arising components, technologies, protocols, communications mediums, or the like may be used as a communications interface in a given device in an ETS.

“Content” and “Digital Content” (which are used interchangeably herein) refer to data that that may be presented, using a suitable presentation device, to a user in a humanly perceptible format. When presented to a human, the data becomes “information.” Non-limiting examples of content include text documents, spreadsheets, photos, videos, text messages, chat data, images, graphics, television programs, streaming video, music, or otherwise. Content may include, for example and not by limitation, one or more sounds, images, video, graphics, characters or otherwise. The content may originate from any source, including live and/or recorded, expanded reality, virtual reality, computer generated, or otherwise. The content may be presented to a given user using any user device and any user interface. Content may be stored, processed, communicated, or otherwise utilized. Content may identify artists, events, venues, and other aspects (as defined above).

“Coupling” herein refers to the establishment of a communications link between two or more elements of a given system. A coupling may utilize any known and/or later arising communications and/or networking technologies, standards, protocols or otherwise. Non-limiting examples of such technologies include packet switch and circuit switched communications technologies, with non-limiting examples including, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used, with non-limiting examples including, the TCP/IP suite of protocols, ATM (Asynchronous Transfer Mode), the Extensible Message and Presence Protocol (XMPP), Voice Over IP (VOIP), Ethernet, Wi-Fi, CDMA, Z-WAVE, Near Field Communications (NFC), GSM/GRPS, TDMA/EDGE, EV/DO, WiMAX, SDR, LTE, MPEG, BLUETOOTH, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling.

“Data” herein refers to any representation of facts, information or concepts in a form suitable for processing, storage, communication, or the like by one or more electronic device processors, data stores, routers, gateways, or other data processing and/or communications devices and systems. Data, while and/or upon being processed, may cause or result in an electronic device or other device to perform at least one function, task, operation, provide a result, or otherwise. Data may be communicated, processed, stored and/or otherwise exist in a transient, non-transient, transitory and/or non-transitory form, as determined by any given state of such data, at any given time. For a non-limiting example, a given data packet may be non-transitory while stored in a storage device, but transitory during communication of the given data packet from a first device or system to a second (or more) device or system. As used herein and when received and stored in one or more of a cache, a memory, a data storage device, or otherwise, the given data packet has a non-transitory state. For example, and not by limitation, data may take any form and may be stored, in a data store, in a data file or other structure, hierarchy, or the like.

“Data store” herein refers to any device or combinations of devices, and/or components of a device, combinations of components of one or more devices, or the like configured to store data and computer instructions on a temporary, permanent, non-transitory, non-transient, and/or other basis. A data store is also referred to herein as a “computer readable medium” and/or a “non-transitory computer readable medium.” A data store may store data and computer instructions in any form, such as electrically, magnetically, physically, optically, or otherwise. A data store may include a cache on a processor, memory devices, or other physical component with non-limiting examples including random access memory (RAM) and read only memory (ROM) devices, and the like. A data store may include one more storage devices, with non-limiting examples including electrical storage drives such as EEPROMs, Flash drives, Compact Flash (CF), Secure Digital (SD) cards, Universal Serial Bus (USB) cards, and solid-state drives, optical storage drives such as DVDs and CDs, magnetic storage drives such as hard drive discs, magnetic drives, magnetic tapes, memory cards, and others. Any known or later arising data storage device technologies may be utilized for a given data store. Available storage provided by a given one or more data stores may be partitioned or otherwise designated by a storage controller as providing for permanent storage and temporary storage. Non-transitory data, computer instructions, or other the like may be suitably stored in a data store permanently or temporarily. As used herein, permanent storage is distinguished from temporary storage, with the latter providing a location for temporarily storing data, computer instructions, variables, or the like for a then arising or soon to arise data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transitory and/or transient storage of data. Permanent storage and/or temporary storage may be used to store data and computer instructions which, while communicated may be transitory or transient, but while stored, is defined herein to be a form of non-transitory and non-transient data and/or computer instruction.

“Device” herein refers to any known or later arising electrical device configured to, singularly and/or in combination, communicate, manipulate, output (e.g., for presentation as information to a human), process, store, or otherwise utilize data. Non-limiting examples of devices include personal computers (e.g., a THINKPAD™ computer manufactured by Lenovo Corporation), table computing devices (e.g., an IPAD™ manufactured by Apple Inc. of Cupertino, California, USA), a smart phone (e.g., a GALAXY S24™ manufactured by Samsung Corporation), and other devices configured to enable a given user to provide edits to one or more instances of digital content.

“Instruction” (which is also referred to herein as a “computer instruction”) herein refers to a non-transitory processor executable instruction, associated data structures, sequence of operations, program modules, or the like. An instruction may be stored in a data store or otherwise for use and execution by a processor in a device, server, or the like. An instruction is described by an instruction set. It is commonly appreciated that instruction sets are often processor specific and accordingly an instruction may be executed by a processor in a language format (e.g., a machine language format) that is translated from a higher level programming language (e.g., C++). An instruction may be provided using any form of known or later arising programming; non-limiting examples including declarative programming, imperative programming, functional programming, procedural programming, stack based programming, object-oriented programming, and otherwise. An instruction may be performed by using data and/or content stored in a data store on a transient, non-transient, transitory and/or non-transitory basis, as may arise for any given data, content and/or instruction. While the computer code provided by one or more instructions is being utilized to instruct and/or configure a device, server, or the like to perform one or more than arising or later occurring operations, such use is herein deemed to occur on a non-transient and non-transitory basis.

“Module” herein refers to and, when claimed, recites definite structure for a device that is configured to provide at least one feature and/or output signal and/or perform at least one function including one or more of the features, output signals and functions described herein. A module may provide the one or more functions using computer engines, processors, computer instructions, applications, modules, and the like. When a feature, output signal and/or function is provided, in whole or in part, using a processor, one more software components may be used, and a given module may include a processor configured to execute computer instructions. A person having ordinary skill in the art (a “PHOSITA”) will appreciate that the specific hardware and/or computer instructions used for a given implementation will depend upon the functions to be accomplished by a given module. Likewise, a PHOSITA will appreciate that such computer instructions may be provided in firmware, as embedded software, provided in a remote and/or local data store, accessed from other sources on an as-needed basis, or otherwise. Any known or later arising technologies may be used to provide a given module and the features and functions supported therein.

“Plug-in” (which are also commonly referred to as an “add-on” by the MOZILLA foundation, as an “add-in” by MICROSOFT, as an “extension” by GOOGLE, or the like), herein refers to one or more computer instructions that are provided as a software component that adds one or more specific features to an existing application, such as an existing digital content editor. For at least one implementation of the present disclosure, a plug-in may utilize services provided by a host application. The plug-in typically registers with the host application and a protocol is utilized by which data may be exchanged by and between the host application and the plug-in. For at least one implementation, a plug-in may be implemented as a shared library which gets dynamically loaded when a corresponding host application is instantiated.

“Power Supply/Power” herein refers to any known or later arising technologies which facilitate the providing to and/or use by a device of electrical power. Non-limiting examples of such technologies include batteries, power converters, inductive charging components, line-power components, solar power components, and otherwise.

“Processor” herein refers to one or more known and/or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, multi-threaded, and otherwise.

“Security Component/Security Module/Security” herein refers to any known or later arising components, processors, computer instructions, modules, and/or combinations thereof configured to secure data as communicated, processed, stored, output for presentation to a user, or otherwise manipulated. Non-limiting examples of security components include those which implement encryption/decryption standards, such as an Advanced Encryption Standard (AET), and transport security standards, such as Transport Layer Security (TLS) or Secure Sockets Layer (SSL).

“Server” herein refers to one or more devices that include computer hardware and/or computer instructions that provide functionality to one or more other programs or devices (collectively, “clients”). Non-limiting examples of servers include content servers, database servers, file servers, application servers, web servers, communications servers, virtual servers, computing servers, and the like. Servers may be combined into clusters (e.g., a server farm), logically or geographically grouped, combined into neural networks, or otherwise configured and/or utilized. Any known or later arising technologies may be used for a server. A server may instantiate one or more computer engines as one or more threads operating on a computing system having a multiple threaded operating system, such as the WINDOWS, LINUX, APPLE OS, ANDROID, and other operating systems, as an application program on a given device, as a web service, as a combination of the foregoing, or otherwise. An Application Program Interface (API) may be used to support an implementation of the present disclosure. A server may be provided in the virtual domain and/or in the physical domain. A server may be associated with a human user, a machine process executing on one or more computing devices, an API, a web service, instantiated on the Cloud, distributed across multiple computing devices, or otherwise. A server may be any electronic device configured to communicate data using a network, directly or indirectly, to another device, to another server, or otherwise.

“Substantially simultaneous(ly)” herein refers to an absence of a greater than expected and humanly perceptible delay between a first event or condition and a second event or condition. Substantial simultaneity may vary in a range of quickest to slowest expected delay, to a moderate delay, or to a longer delay.

“User” herein refers to a single person and/or a group of users who are being presented, via a suitable user device, with a given content, which may include a current episode content and/or past episode content, at a given time.

“User Device (UD)” herein refers to a device configured for use by a user to communicate, generate, compute, present, process, store, or otherwise manipulate data and/or information. Non-limiting examples of user devices include smartphones, laptop computers, tablet computing devices, desktop computers, smart televisions, smart glasses, virtual reality glasses, expanded reality glasses, earbuds/headphones and other audible output devices, and other devices.

“User Interface” herein refers to one more components, provided with or coupled to a device configured to receive information from and/or present information to a user and convert information to data and vice versa. A user interface may include one more Additional I/O interfaces, Audio I/O interfaces, and Visual I/O interfaces.

“Visual I/O interface” herein refers to one or more components, provided with or coupled to a device, configured to support a receiving and/or presenting of humanly perceptible visual content to one or more users. A visual I/O interface may be configured to support the receiving and presenting of visual content (which is also referred to herein as being “visible signals”) to users. Such visible signals may be in any form, such as still images, motion images, expanded reality images, virtual reality images, and otherwise. A visual I/O interface includes hardware and computer instructions (herein, “visible technologies”) which supports the input by and output of visible signals to users via a device. Such visible technologies may include technologies for converting images (in any spectrum range) into humanly perceptible images, converting content of visible images into a given user's perceptible content, such as by character recognition, translation, playback rate adjustment, playback frequency adjustment, and otherwise. A visual I/O interface may be configured to use one or more display devices, such as an internal display and/or external display for a given device with the display(s) being configured to present visible signals to a user. A visual I/O interface may be configured to use one or more image capture devices to capture content. Non-limiting examples of image capture devices include lenses, cameras, digital image capture and processing software, and the like. Accordingly, it is to be appreciated that any existing or future arising visual I/O interfaces, devices, systems and/or components may be utilized by and/or in conjunction with a device to facilitate the capture, communication and/or presentation of visible signals to a user.

### Smart Content Access System (SCAS) 100

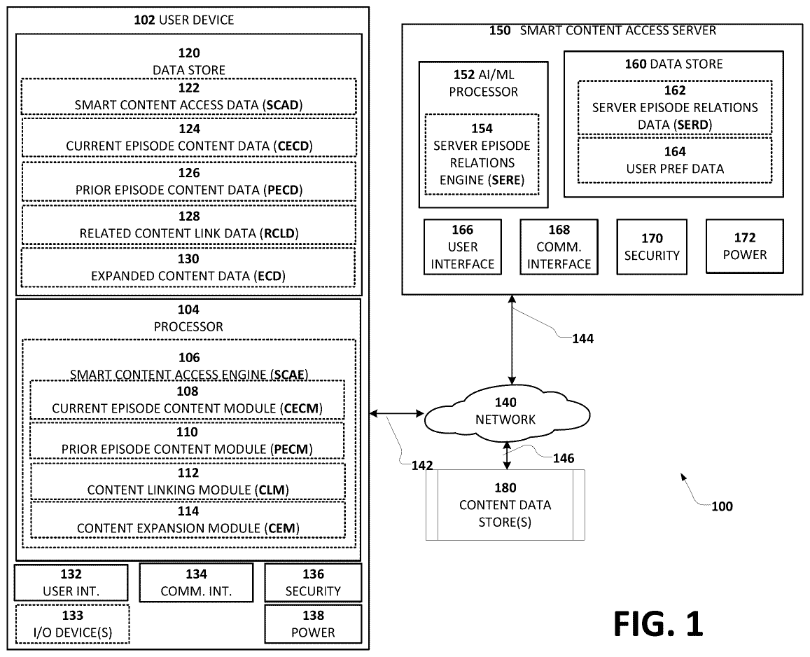

As shown in FIG. 1 and for at least one implementation of the present disclosure, a smart content access system (SCAS) 100, may include one or more combinations and/or permutations of: at least one user device (UD) 102, a smart content access server (“server”) 150, one or more content data stores (CDS) 180, and a network 140, which for at least one implementation may be implemented using a Cloud based network. The SCAS 100 also includes various couplings including a user device coupling (UDC) 142, a server coupling 144, and one or more CDS couplings 146. For at least one implementation, the CDS 180 may provide one or more of current episode content data and/or prior episode content data.

### User Device (UD) 102

As shown in FIG. 1 and for at least one implementation, a UD 102 may include a user device processor (UDP) 104 that may be configured as one or more “processors” as defined above. The UD 102 may further include a UD data store 120 that may be configured as one or more “data stores,” as defined above. The UD 102 may further include a UD user interface 132 that may be configured as one or more “user interfaces,” as defined above. The UD 102 may further include at least one UD input/output (I/O) device 133 that may include one more “audible technologies,” “visible technologies” (as respectively defined above), or the like. The UD I/O device(s) 133 utilized for a given implementation, may be provided in conjunction with a given UD 102 and/or separately and coupled to the given UD 102. The UD 102 may further include at least one UD communications interface 134 that may be configured as one or more “communications interfaces,” as defined above. The UD 102 may further include a UD security module 136 that may be configured as one or more security modules, as defined above. The UD 102 may further include a UD power module 138 that may be configured as one or more “power modules,” as defined above. The UD 102 may further include one or more other modules, components, engines, applications, data stores, data files, computer instructions, or the like that are commonly provided with and/or coupled to a given UD 102, which may be currently known and/or later developed and/or provided, and with respect to a given implementation of the present disclosure may be agnostic to and/or specifically configured to facilitate one or more implementations of the present disclosure. A bus (not shown) may couple the various UD components, modules and the like to each other. The bus may take any form and may use any commonly known in the art technologies and/or later arising technologies which couple one or more components of a device to one or more other components of the device.

### User Device Processor (UDP) 104

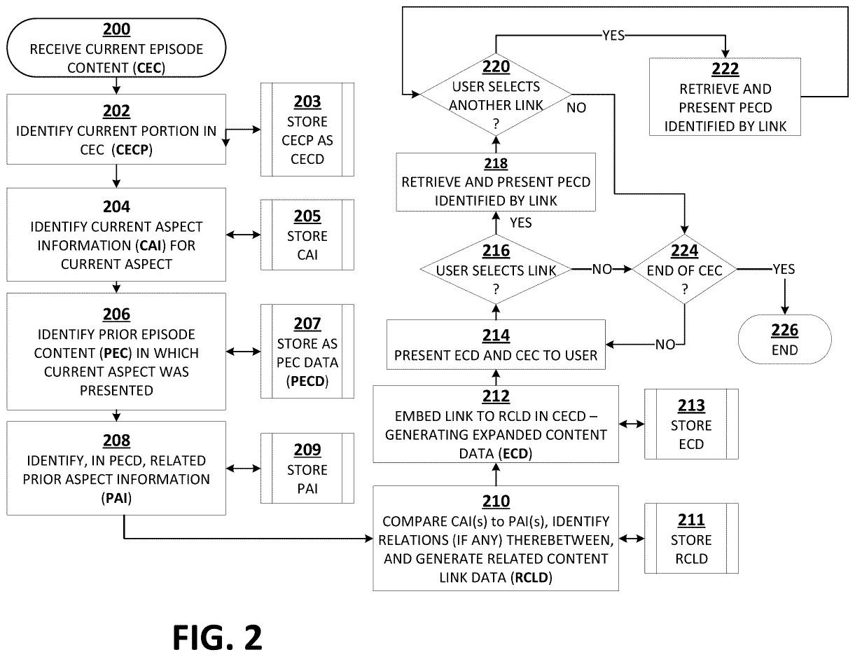

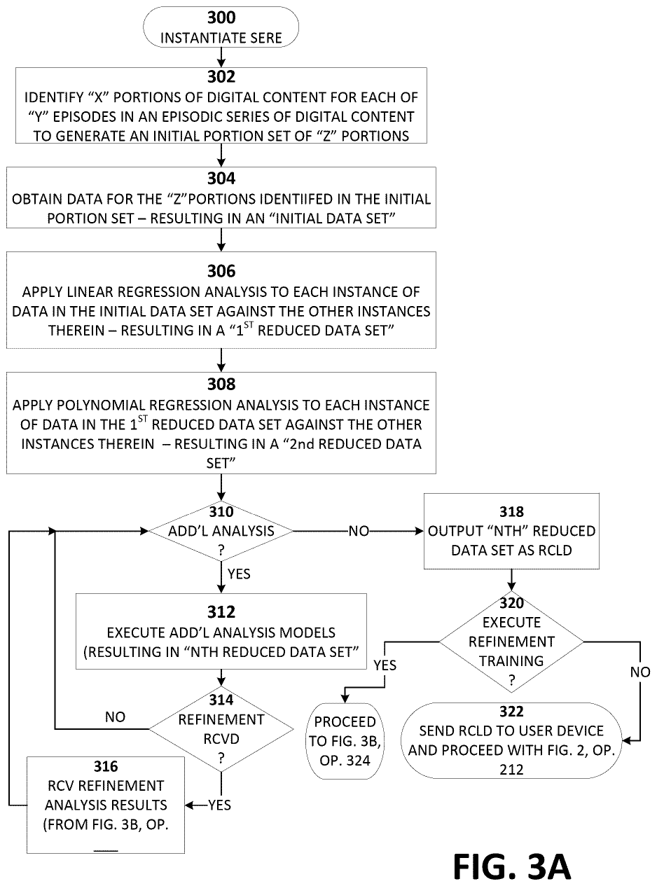

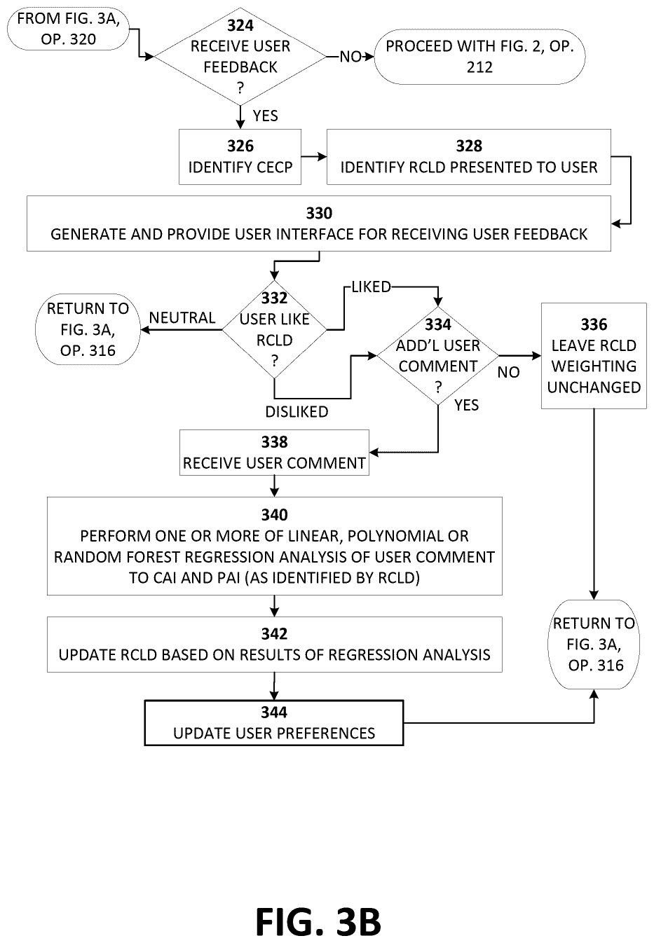

For at least one implementation, the UDP 104 may be configured to execute at least one first computer instruction (1CI) which instantiates a smart content access engine 106 (SCAE). The SCAE 106 configures a given UD 102 to perform at least one smart content access operation (SCAO). For at least one implementation, the UDSCAOs are further described hereinbelow and with respect to FIGS. 2 and 3A-3B. For at least one implementation, the 1CI may be non-transitorily stored as SCA data (SCAD) 122 in the UD data store 120. For at least one implementation, the 1CI may be non-transitorily stored on the Network 140, for example in the Cloud, the server 150, and/or otherwise and retrieved therefrom for use, or instructed to be executed by another processor in a distributed, virtualized, cooperative or other processing environment.

As shown in FIGS. 1 and 2 and for at least one implementation, the UDP 104, may be further configured to execute at least one current episode content recognition instruction (CECRI), which are also referred to herein as second computer instructions (2CI). The CECRI, when executed by the UDP 104 instantiate a current episode content module (CECM) 108. The CECM 108 may configure the UD 102 to perform at least one CEC recognition operation (CECRO). For at least one implementation, the 2CI and results obtained from performance of one or more CECROs may be non-transitorily stored as CEC data (CECD) 124 in the UD data store 120. For at least one implementation, the 2CI may be non-transitorily stored on the Cloud 140, the server 150, and/or otherwise and retrieved therefrom for use, or instructed to be executed by another processor in a distributed, virtualized, cooperative or other processing environment.

As shown in FIG. 1 and for at least one implementation, the UDP 104, may be further configured to execute at least one user device prior episode content recognition instruction (PECRI), which are also referred to herein as third computer instructions (3CI). The PECRI, when executed by the UDP 104, instantiate a prior episode content module (PECM) 110. The PECM 110 may configure the UD 102 to perform at least one prior episode content recognition operation (PECRO). For at least one implementation, the 3CI and results obtained from performance of one or more of the UDPECROs may be non-transitorily stored as prior episode content data (PECD) 126 in the UD data store 120. For at least one implementation, the 3CI may be non-transitorily stored on the Cloud 140, the server 150, and/or otherwise and retrieved therefrom for use, or instructed to be executed by another processor in a distributed, virtualized, cooperative or other processing environment.

As shown in FIG. 1 and for at least one implementation, the UDP 104, may be further configured to execute at least one content link instruction (CLI), which are also referred to herein as fourth computer instructions (4CI). The CLI, when executed by the UDP 104, instantiate a content linking module (CLM) 112. The CLM 112 may configure the UD 102 to perform at least one content linking operation (CLO). For at least one implementation, the 4CI and results obtained from performance of one or more of the CLOs may be non-transitorily stored as related content link data (RCLD) 128 in the UD data store 120. For at least one implementation, the 4CI may be non-transitorily stored on the Cloud 140, the server 150, and/or otherwise and retrieved therefrom for use, or instructed to be executed by another processor in a distributed, virtualized, cooperative or other processing environment.

As shown in FIG. 1 and for at least one implementation, the UDP 104, may be further configured to execute at least one content expansion instruction (CEI), which are also referred to herein as fifth computer instructions (5CI). The CEI, when executed by the UDP 104, may instantiate a content expansion module (CEM) 114. The CEM 114 may configure the UD 102 to perform at least one content expansion operation (CEO). For at least one implementation, the 5CI and results obtained from performance of one or more of the CEOs may be non-transitorily stored as expanded content data (ECD) 130 in the UD data store 120. For at least one implementation, the 5CI may be non-transitorily stored on the Cloud 140, the server 150, and/or otherwise and retrieved therefrom for use, or instructed to be executed by another processor in a distributed, virtualized, cooperative or other processing environment.

As shown in FIG. 2 and for at least one implementation of the present disclosure, an SCAE 106 may be configured to perform one or more SCAOs.

As per Operation 200 and for at least one implementation, the SCAOs may include retrieving, receiving, downloading, streaming, or otherwise making available for presentation to a user, e.g., via a user device user interface 120 and one or more user device I/O devices 122, (herein, “receiving”) a current episode content (CEC) of a given digital content.

As per Operation 202 and for at least one implementation, the SCAOs may include identifying at least one portion of a current episode content (herein, a “current episode content portion (CECP)”). The identifying of the CECP may occur on any portion of the CEC including, without limitation, an entirety of all of the portions of the CEC. For example, a digital content presented in the form of a movie may include various chapters. A current aspect will exist in each of the various chapters and the current aspect may apply to multiple chapters of a given digital content. For example, a current aspect may include a character, such as DARTH VADER. The character may be presented in one chapter or multiple chapters of the given digital content.

As per Operation 203 and for at least one implementation, the CECP identified may be stored as current episode content data (CECD) in the data store 112, on the Cloud/Network 140, at the server 150, and/or otherwise. For at least one implementation, the operations occurring per Operations 202 and 203 may be implemented by the CECM 108 and may include one or more CECROs.

As per Operation 204 and for at least one implementation, the SCAOs may include identifying current aspect information (“CAI”) about the CECP (e.g., the character DARTH VADER), such as the origin, life story, relationships, and the like of the character/current aspect may be relevant to one or more instances in the given digital content in which the character/current aspect appears. As per Operation 205 and for at least one implementation, the CAI may be stored in the data store 112, on the Cloud/Network 140, at the server 150, and/or otherwise. For at least one implementation, the operations occurring per Operations 204 and 205 may be implemented by the CECM 108 and may include one or more CECRO.

As per Operation 206 and for at least one implementation, the SCAOs may include identifying, in the one or more prior episodes, one or more instances of prior episode content (PEC) that relate to the current aspect in the current episode content. As per Operation 207 and for at least one implementation, the identified PEC may be stored, as PECD, in the data store 112, on the Cloud, at the server 150, or otherwise. For at least one implementation, the operations occurring per Operations 206 and 207 may be implemented by the PECM 110 and may include one or more PECRO.

As per Operation 208 and for at least one implementation, the SCAOs may include identifying in the PEC identified per Operation 206, one or more instances of prior aspects (if any) and information therefor that relate to the CAI identified per Operation 204 (such related prior aspect information is referred to herein as “prior aspect information (PAI)”). As per Operation 207 and for at least one implementation, the PAI may be stored in the data store 112, on the Cloud, at the server 150, or otherwise. For at least one implementation, the operations occurring per Operations 208 and 209 may be implemented by the PECM 110 and may include one or more PECRO.

As per Operation 210 and for at least one implementation, the SCAOs may include comparing the CAI with the one or more instances of the PAI to identify one or more, if any, relations therebetween. For a non-limiting example, a comparison of a prior episode in STAR WARS in which DARTH VADER identifies to LUKE that he is LUKE's father with another, prior episode in which DARTH VADER and LUKE battle may identify the familial relationship that a user may find helpful in understanding why one character does not end the life of the other character in the current episode. The one or more results generated from the comparing of the CAI(s) with the PAI(s) may result in one or more instance of related content link data (RCLD). As per Operation 211 and for at least one implementation, the RCLD may be stored in the data store 112, on the Cloud, at the server 150, or otherwise. For at least one implementation, the operations occurring per Operations 210 and 211 may be implemented by the CLM 112 and may include one or more CLO.

As per Operation 212 and for at least one implementation, the SCAOs may include embedding, inserting, associating, linking or otherwise associating a user selectable code segment (herein a “link”) into the RCLD, in the CECD (herein, such operations are referred to as an “embedding”); resulting in one or more instances of Expanded CECD (ECD). As per Operation 213 and for at least one implementation, the ECD may be stored in the data store 112, on the Cloud, at the server 150, or otherwise. For at least one implementation, the operations occurring per Operations 212 and 213 may be implemented by the CEM 114 and may include one or more CEO.

For at least one implementation, the link generated per Operation 212 may take any form that identifies to a user that additional content is available and allows the user to select the additional content for presentation thereto. Non-limiting examples of such a link include: a hyper-link (e.g., an HTML link); an accordion (e.g., a user interface element that allows the user to expand the RCLD, while contracting the CECD); a bento menu (e.g., a user interface element that presents to the user menu with the various grid items identifying a given RCLD); a breadcrumb (e.g., a user interface element that includes a trail of links that enable the given user to delve into one or more PECs that include PAIs related to one or more CAI); a button (e.g., a user interface element that present an oval, square, rectangular or similar shape that, when selected, instructs the SCAE to launch another window, browser, web page or the like in which the PEC identified in the RCLD may be presented); a card (e.g., a user interface element in which the PEC may be presented in a separate window, as commonly implemented by another instance of the PECM); a carousel (e.g., a user interface element in which the PEC may be presented along with one or more additional links embedded therein); and the like.

As per Operation 214 and for at least one implementation, the SCAOs may include presenting the ECD to the user. For at least one implementation, the ECD may be presented in place of the CEC and/or in conjunction with one or more portions of the CEC that are or are not linked to one or more instances of PEC. For example, a first portion of the CEC may not be linked to PEC while a second portion of the CEC is linked to PEC. Accordingly, a presentation of the ECD may include presenting the first portions, as obtained from the CEC, and the second portions with the link, identified in the RCLD, and as presented by the user interface using one or more of the link embedding approaches described above and/or as otherwise known in the current art and/or later known. It is to be appreciated that the embedding of the link may occur such that the content of the CEC and the PEC remain unaltered and a derivative work under United States and other countries copyright laws is not generated. Instead, a link between the CEC and the PEC may be provided that the user may select to obtain additional aspect information.

As per Operation 216 and for at least one implementation, the SCAOs may include determining, during the presentation of a given ECD, whether the user has selected the embedded RCLD. If “YES,” the process may include proceeding to Operation 218. If “NO,” the process may include proceeding to Operation 224.

As per Operation 218 and for at least one implementation, the SCAOs may include retrieving and presenting to the user the PECD identified by the user selected RCLD, as selected from the ECD, which identifies the PECD (as per Operations 210 and 212).

As per Operation 220 and for at least one implementation, the SCAOs may include determining whether the user selects another RCLD in the ECD (when one is present therein). If “YES,” the process may proceed to Operation 222. If “NO,” the process may proceed to Operation 224.

As per Operation 222 and for at least one implementation, the SCAOs may include retrieving and presenting the PECD identified by the RCLD in the ECD, as selected by the user. For at least one implementation, the ECD may include multiple RCLDs that link to multiple instances of PECD that relate to one or more instances of CAI in a given CEC. Like layers of an onion, the ECD and RCLD may identify multiple layers of PEC that includes PAI that relate to one or more current aspects of one or more given CEC. Implementations may be provided which enable the user to dive deeper into one or more aspects of the CEC, by selecting one or more links to PEC, as so desired by the given user and when such related aspect information is available and has been identified, as per Operations 206-208. When the desired links have been selected and the PECD so identified by the given link(s) have been retrieved and presented, as indicated by the “NO” path from Operation 220, the process may proceed to Operation 224.

As per Operation 224 and for at least one implementation, the SCAOs may include determining whether an end to the CEC has been reached or the user has otherwise discontinued the presentation of the current episode. If “YES,” the process end, as per Operation 226. If “NO,” the process may include returning to Operation 214.

For at least one implementation of the present disclosure, one or more of the Operations identified above and in FIG. 2 may be executed automatically, semi-automatically and/or manually. As used herein and with respect to the Operations depicted in FIG. 2, “automatically” means that the UDP 104, alone and/or in conjunction with the server 150, performs one or more of the Operations without requiring user input or oversight. For example, the UD 102 may be configured to automatically present PAI and PEC in a sidebar or the like when available and whenever an RCLD is present in the ECD then being presented to the given user. Similarly, “automatic” means that the CAI and PAI may be identified without user input.

As used herein, “semi-automatically” means that the UDP 104, alone and/or in conjunction with the server 150, performs one or more of the Operations but with user input or oversight. For example, the UD 102 may be configured to automatically identify PAI and PEC that a user, which may be the given user or another user, may determine is to be presented to the given user in a sidebar or the like when available and whenever an RCLD is present in the ECD then being presented to the given user. Similarly, “semi-automatic” means that the CAI and PAI may be identified but with user input.

As used herein, “manually” means that a user identifies and performs each of Operations 202-211 and the UDP 104, alone and/or in conjunction with the server 150, performs one or more of the remaining Operations in FIG. 2 but with user input or oversight. For example, and not by limitation, with respect to Operation 212 the UD 102 may be configured to embed links to the RCLD that a user selects to be so embedded.

For at least one implementation of the present disclosure, Operations 202-205 may be performed by analyzing an audio track for with the CEC. For example, an audio track may refer to a prior instance wherein a current aspect in the CEC (e.g., a character's name) is described, discussed, introduced or otherwise presented to a user viewing a given instance of CEC. Based on the presence of the current aspect (e.g., the character name) in the CEC, the UDSCAE 106 may be configured to perform operations 206-209 (e.g., search the PEC for PAI in which one or more instances of the current aspect (e.g., the character's name) was previously used).

Similarly, and for at least one implementation of the present disclosure, Operations 202-205 may be performed by analyzing other aspects in the CEC. For example, the CEC may include a depiction of a cityscape (e.g., for the city of Paris) - the cityscape depiction being an instance of a CAI. Based on the cityscape, the UDSCAE 106 may be configured to perform Operations 206-209 (e.g., search for instances where one or more PEC occur in Paris).

Further, and for at least one implementation, Operations 202-205 may be performed by combining two or more aspects in the CEC. For example, an audio track aspect and a cityscape aspect may be combined to identify PAI in PEC in which a given character, as indicated by the audio track aspect, was presented as being in and/or associated with a given cityscape, e.g., Paris.

For at least one implementation, audio tracks for the given user being presented with the CEC may be captured, analyzed and used to determine which CAI is of interest to the given user and to search for and identify PAI, in one or more instances of PEC, which relate to the CAI. For example, a given user watching an episode of STAR WARS may ask the UD 102 what the relationship between PRINCEESS LEIA™ and LUKE is, if any. Such query may occur when one or more of PRINCESS LEIA and LUKE are or are not being presented in a CEC. Based on such user query, the UDSCAE 106 may be configured to perform Operations 206-209 and identify instances in one or more PEC where the relationship between PRINCESS LEIGA and LUKE is presented, discussed, implied, or otherwise.

Accordingly, it is to be appreciated that the Operations of FIG. 2 may be initiated based on any given user's input and may occur based on requests by a given user, the CAI presented in a given instance of CEC, multiple instances of CEC, or otherwise.

### Smart Content Access Server (Server) 150

As further shown in FIG. 1, the SCAS 100 may include at least one server 150. For at least one implementation, the server 150 may be provided by one or more AWS, GOOGLE, MICROSOFT or other Cloud based systems. Such Cloud based systems may be distributed, centralized, localized or otherwise provided.

The server 150 may be configured to include at least one server processer (SP) 152. For at least one implementation, the SP 152 may be configured to implement one or more server AI/ML processes (SAIP). For at least one implementation, the SP 152 may use one or more neural processing units (NPU) for the SAIP. The NPU may be Cloud based or otherwise configured.

For at least one implementation, the SAIP may include the SP 152 executing one or more Server Episode Relations Instructions (SERI) which, when executed, instantiate a server episode relations engine (SERE) that configures the SP 152 to perform Server Content Recognition Operations (SCRO). The SERI are also referred to herein as first (1^{st}) server computer instructions (1SCI). The SERI may be stored in a server data store 160 that is coupled to the SP 152. The SCRO may include generating a server content recognition model (SCRM) that facilitates identification of relationships between CAIs and PAIs across multiple instances of episodic digital content. The SCRM may be initially trained using a supervised training model.

One implementation of such a training model is shown in FIGS. 3A-3B and is further described below. Once initially trained, the SCRM may be periodically refined using user feedback. For example, users may indicate whether information provided using a given RCLD is helpful or not helpful. Common user interface elements, such as a “thumbs-up,” “like,” “thumbs-down,” dislike, or other user indication may be used as feedback that the SCRM may use to refine when a given PAI is deemed to be relevant or not relevant to a given CAI. For at least one implementation, refinement learning of the SCRM may occur on a population, sub-population, user or other basis. One or more user preferences may be indicated for the types of PAI that a given user (or other grouping thereof) may find to be relevant to a given CAI. For example, a population of users that are KANSAS CITY CHIEFS™ fans may find information to be relevant regarding a prior outing between the CHIEFS and an NFL™ division rival, such as the DENVER BRONCOS™ while not finding other information to be relevant regarding a prior outing against a non-division rival, such as the DALLAS COWBOYS™. Another population of users may find different categories of information from PAIs relevant to one or more given instances of CAI. Such data may used to populate one or more instances of user content relationship data preferences that the SCRM may use to further refine, based on one or more user's feedback, when a given instance of an CAI and a PAI are deemed sufficiently informative (to the given one or more users) that an RCLD should be generated.

As shown in FIG. 3 and for at least one implementation of the present disclosure, the SPERE is initially trained using a supervised learning process. As per Operation 300 and for at least one implementation, the process may include the SP 152 instantiating the SERE 154.

As per Operation 302 and for at least one implementation, the process may include identifying “X” unique instances of digital content, wherein each instance of the digital content is associated with a given episode of multiple episodes of content that are provided in an episodic series or similarly related sequence of content. For at least one implementation, the episodic series includes at least “Y” episodes. For at least one implementation X equals one hundred (100) unique instances of digital content and Y equals five (5) episodes, resulting in an identification of an initial data set “Z” (where Z=X*Y) of at least five-hundred (500) unique portions of digital content.

As per Operation 304 and for at least one implementation, the process may include obtaining data (herein, “related data”) for one or more, which may include each, of the Z portions identified in the initial data set. For at least one implementation, the data may include any form of data provided in and/or in conjunction with, or otherwise associated with a given portion of digital content identified in the initial data set. For at least one implementation, the data may include metadata. For at least one implementation, the data may include audio data. For at least one implementation, the data may include a transcription of an audio track associated with the portion. For at least one implementation, the data may include pictorial, graphical, video or other forms of visual data. For at least one implementation, the data may include user responses, external data, and the like. For other implementations combinations and permutations of data and other forms of data may be obtained. Operation 304 results in a generation of an “initial data set.”

As per Operation 306 and for at least one implementation, the process may include performing a linear regression analysis on each of the Z portions of data, in the initial data set, with respect to one or more of the other data in the initial data set, for relationships between a given portion and another one or more of the portions of digital content identified per Operation 302. For at least one implementation, such analyzing may include parallel execution of Operations 202-211 across multiple processors. For at least one implementation, the analysis may include one or more sub-processes such as audio analysis, video/pictorial/graphical name, image, and likeness analysis and/or other forms of data analysis. For a non-limiting example, using the data obtained per Operation 304, the SCRO may include use of a linear regression analysis to identify those portions in the initial data set where DARTH VADER appears, is mentioned, or is discussed in two or more of the digital content portions. The results obtained from the linear regression analysis, typically will result in a reduction in the initial data set generated by Operation 304. The linear regression analysis may result in a first (1^{st}) reduced data set.

As per Operation 308 and for at least one implementation, the process may include performing a polynomial regression analysis on each of the portions of data identified in the 1^{st} reduced data set with respect to one or more of the other data in the 1^{st} reduced data set—resulting in a second (2^{nd}) reduced data set. For at least one implementation, Operations 306 and 308 (and/or other operations) may be reversed such that, e.g., a polynomial regression analysis is performed before a linear regression analysis.

As per Operation 310 and for least one implementation, the process may include determining whether additional analysis of the 2^{nd} through Nth reduced data sets is to be performed (with “N” being an integer). For at least one implementation, additionally analysis may be automatically performed when a then existing Nth reduced data set includes more than a given number (e.g., three (3)) of relationships between a given portion of digital content and another given portion of digital content. It is to be appreciated that as the given number increases the usefulness of a given instance of RCLD may result in a given user experiencing information overload. Thus, smaller data sets and lesser RCLDs may be generated to facilitate user not experiencing an information overload. If a result of the determining is “YES,” the process may proceed with Operation 312. If a result of the determining is “NO,” the process may proceed with Operation 314.

As per Operation 312 and for at least one implementation, the process may include executing one or more additional analysis models on the Nth reduced data set. A non-limiting example may include executing a random forest decision tree analysis. The results of the additional analysis are an Nth reduced data set. The process may then return to Operation 310.

As per Operation 314 and for at least one implementation, the process may include determining if a refinement analysis result has been received. The refinement analysis is described below with respect to FIG. 3B. If “NO,” the process may return to Operation 310. If “YES,” the process may proceed to Operation 316.

As per Operation 316 and for at least one implementation, the process may include receiving analysis results, as generated, for at least one implementation, per the operations shown in FIG. 3B. The process may then return to Operation 310.

As per Operation 318 and for at least one implementation, the process may include outputting the Nth reduced data set as the RCLD (see FIG. 2, Operation 210).

As per Operation 320 and for at least one implementation, the process may include determining whether refinement training is to be performed. If “NO,” the process may proceed to Operation 322. If “YES,” the process may proceed to Operation 324, as shown in FIG. 3B.

As per Operation 322 and for at least one implementation, the process may include the SP 152 sending the RCLD to a user device (UD) 102 at which instance the UD 102 may embed a link to the RCLD in one or more ECDs, as per Operation 212 of FIG. 2.

As shown in FIG. 3B, Operation 324 and for at least one implementation, the process may include determining whether user feedback is to be received regarding an RCLD that was previously generated. The RCLD may have been previously generated using AI/ML (e.g., as per Operations 302-318) or manually (e.g., as per Operations 200-210). If “NO,” the process may proceed with FIG. 2, Operation 212. If “YES,” the process may proceed to Operation 326 and with an implementation for a refinement analysis process which generates a refinement analysis result.

As per Operation 326 and for at least one implementation, a refinement analysis process may include identifying a current episode content portion (CECP) with respect to which a given user is providing, will provide, and/or has provided feedback.

As per Operation 328 and for at least one implementation, the process may include the server identifying an RCLD that was presented to the user with regard to the CECP identified per Operation 326.

As per Operation 330 and for at least one implementation, the process may include generating and communicating to the user device (UD) 102 a user interface by which the given user may provide feedback regarding one or more instance of ECD, as identified by a given RCLD, presented to the given user, e.g., as per one or more of the operations of FIG. 2. Operation 300 may be performed at any time including prior to one or more of Operations 326 and 328.

As per Operation 332 and for at least one implementation, the process may include determining whether the given user “Liked,” “Disliked” or otherwise indicated a preference for, against or neutral with respect to the ECD identified by the given RCLD. If a “Liked” response was received, the process may proceed to Operation 334 and with an application of a potentially positive increase in a weighting of the given PEC to the given CEC. If a “Disliked” response is received, the process may proceed to Operation 334 and with an application of a potentially negative increase in a weighting of the given PEC to the given CEC. If a “Neutral” response or no response is received, the process may return to Operation 316, in which instance no increase or decrease occurs in a weighting of the given ECD as identified by the given RCLD—the given RCLD identifying a relationship of the given PAI to the given CAI). For at least one implementation, a user “LIKE,” “DISLIKE,” or “Neutral” reaction to a given ECD may be determined based upon a user reaction. For a non-limiting example, a given user that does not select an RCLD may be inferred as having a “Neutral” reaction to the ECD identified by the RCLD. Similarly, a given user that selects and then spends less than ten (10) seconds reviewing the ECD may be inferred as having a “DISLIKE” to the PEC. Similarly, a given user that selects, reviews and forwards the RCLD to another user or device may be inferred as having a “LIKE” to the PEC. Other implementations may use other forms of user interactions with a given RCLD and a given PEC to infer a user's reaction thereto. Such user reactions may be used in weighing one or more of the PEC, the ECD, and/or the RCLD associated therewith, and updating one or more user preferences, as discussed herein below.

As per Operation 334 and for at least one implementation, the process may include determining is the given user has provided additional comments. The additional comments, if any, may be provided in any form with non-limiting examples including texts, verbal, visual, graphical, and other forms of comments. If “NO,” the process may proceed to Operation 336. If “YES,” the process may proceed to Operation 338.

As per Operation 336 and for at least one implementation, the process may include leaving a current weighting of the RCLD (e.g., as generated per Operations 210 or 318) unchanged. The process may then return to Operation 316, FIG. 3A.

As per Operation 338 and for at least one implementation, the process may include receiving the user comment. As discussed above, the user comment may be received in any form, e.g., text, graphical, verbal, visual, or otherwise.

As per Operation 340 and for at least one implementation, the process may include performing one or more linear, polynomial, random forest, or other regression analysis on the user comment in view of the weighting for the given RCLD which is indicated of a relevance of a given PEC to a given CEC (as identified per Operation 328).

As per Operation 342 and for at least one implementation, the process may include updating the RCLD based on one or more results of the regression analysis. As shown, Operation 342 may relate to user “LIKE” comments and user “DISLIKE” comments. When “LIKE” comments are received a weighting of the RCLD may be increased. When DISLIKE comments are received the weighting of the RCLD may be decreased. For at least one implementation, the weighting may range from zero (0) to one-hundred (100) with a zero rating indicating that the given user did not find the ECD and/or the PEC helpful in understanding the CAI and a 100 rating indicating that the ECD and/or the PEC was extremely helpful. The weighting of a given RCLD may be stored as server episode relations data (SERD) 162 in the server data store 160, in the UD data store 120, on the Cloud, on the network 140, and/or in combinations thereof.

As per Operation 344 and for at least one implementation, the process may include updating one or more user preferences based on one more results of the regression analysis of Operation 340. For at least one implementation, a given RCLD may be utilized with respect to multiple users and a user preference may be used to modify the RCLD to fit the needs, wants and preferences of a given user. The user preferences may be stored as server user preference data (SUPD) 164, e.g., as stored in the server data store 160 and/or as stored on one or more of the UD 102, the server 150, the network 140, or otherwise. The process may then return to Operation 316, FIG. 3A.

It is to be appreciated that the Operations depicted in FIGS. 2, 3A and 3B may occur in the sequence as shown, and/or in any other sequence of operations including one more operations occurring in parallel.

As further shown in FIG. 1 and for at least one implementation, the server 150 may further include at least one user interface 166 coupled to one or more input/output (I/O) devices (not shown). The I/O device(s) may include one more “audible technologies,” “visible technologies” (as respectively defined above), or the like. The I/O device(s) utilized for a given implementation, may be provided in conjunction with a given server 150 and/or separately and coupled to the given server 150.

The server 150 may further include at least one communications interface 168. The communications interface 168 may be configured as one or more communications interfaces, as defined above. The server 150 may further include a security module 170. The security module 170 may be configured as one or more security modules, as defined above. The server 150 may further include a power module 172. The power module 172 may be configured as one or more power modules, as defined above. The server 150 may further include one or more other modules, components, engines, applications, data stores, data files, computer instructions, or the like (herein “components”) that are commonly provided with and/or coupled to a given server - such components may be currently known and/or later developed and/or provided. Such components, for a given implementation of the present disclosure may be agnostic to and/or specifically configured to facilitate one or more implementations of the present disclosure.

Although various implementations have been described above with a degree of particularity, or with reference to one or more individual implementations, those skilled in the art could make alterations to the disclosed implementations without departing from the spirit or scope of the present disclosure. The use of the terms “approximately” or “substantially” means that a value of an element has a parameter that is expected to be close to a stated value or position. As is well known in the art, there may be minor variations that prevent the values from being as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom,” “left” and “right,” “up” or “down,” “first,” “second,” “next,” “last,” “before,” “after,” and other similar terms are used for description and ease of reference purposes and are not intended to be limiting to any orientation or configuration of any elements or sequences of operations for the various implementations of the present disclosure. Further, the terms “coupled,” “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings be interpreted as illustrative of implementations and not limiting. Changes in detail or structure may be made without departing from the basic elements of the present disclosure as described in the following claims.

What is claimed is:

1. A user device comprising:
a user device data store (UDDS);
wherein the UDDS non-transitorily stores first computer instructions which, when executed, instantiate a smart content access engine (SCAE); and
a user device processor (UDP) coupled to the UDDS; and
a user interface coupled to the UDP and an input/output (I/O) device;
wherein the UDP, when executing the first computer instructions, instantiates the SCAE which configures the user device to perform smart content access operations (SCAO) comprising:
identifying, to a user of the user device, prior episode content (PEC) that relates to a given current episode content (CEC);
wherein the CEC is provided in a current episode of a digital content series by a content source;
wherein the digital content series includes the current episode and a prior episode; and
wherein the PEC is provided in the prior episode;
receiving a user request for a presentation of the PEC;
retrieving the PEC from a content source coupled to the user device; and
presenting the PEC to the user via the I/O device.

2. The user device of claim 1,
wherein the UDDS non-transitorily further stores second computer instructions which, when executed by the UDP, instantiate a current episode content module (CECM) which configures the user device to perform current episode content recognition operation (CECRO) comprising:
retrieving the CEC from the content source;
wherein the CEC includes two or more current episode content portions (CECP);
storing the CECP in the UDDS as current episode content data (CECD);
identifying in one of the CECPs, current aspect information (CAI) for a current aspect presented in the CECP; and
storing the CAI in the UDDS.

3. The user device of claim 2,
wherein the CAI identifies at least one aspect of the CEC presented in the CECP.

4. The user device of claim 3,
wherein the at least one aspect is a character occurring in the current episode.

5. The user device of claim 2,
wherein the UDDS non-transitorily further stores third computer instructions which, when executed by the UDP, instantiate a prior episode content module (PECM) which configures the user device to perform prior episode content recognition operation (PECRO) comprising:
searching the content source to identify PEC which include prior presentations of the current aspect;
storing, in the UDDS, at least one result arising from the searching as prior episode content data (PECD);
identifying in the PEC, prior aspect information (PAI) that relates to the CAI for the current aspect presented in the CECP; and
storing the PAI in the UDDS.

6. The user device of claim 5,
wherein the UDDS non-transitorily further stores fourth computer instructions which, when executed by the UDP, instantiate a content linking module (CLM) which configures the user device to perform content linking operations (CLO) comprising:
comparing the CAI to the PAI to identify relations between the CAI and the PAI;
generating, based on a result of the comparing, related content link data (RCLD) for the PAI that has been identified as being related to the CAI; and
storing the PAI in the UDDS.

7. The user device of claim 6,
wherein the UDDS non-transitorily further stores fifth computer instructions which, when executed by the UDP, instantiate a content expansion module (CEM) which configures the user device to perform content expansion operations (CEO) comprising:
retrieving the CECD from the UDDS;
retrieving the RCLD from the UDDS;
generating expanded content data (ECD) by embedding, in the CECD, a link to the PECD identified in the RCLD; and
storing the ECD in the UDDS.

8. The user device of claim 7,
wherein the link in the ECD is selectable by the user during a presentation of the ECD to the user; and
wherein upon selection of the link, a presentation of the CECD includes a presentation of the PECD identified in the RCLD.

9. The user device of claim 8,
wherein during the presentation of the PECD, the presentation of the CECD is temporarily suspended until the presentation of the PECD ends.

10. A computer readable medium non-transitorily storing computer instructions which, when executed by a processor, instantiate a smart content access engine (SCAE) which configures a user device to perform operations comprising:
identifying, to a user of the user device, prior episode content (PEC) that relates to a given current episode content (CEC);
wherein the CEC is provided in a current episode of a digital content series provided by a content source;
wherein the digital content series includes the current episode and a prior episode; and
wherein the PEC is provided in the prior episode;
retrieving the CEC from the content source;
wherein the CEC includes two or more current episode content portions (CECP);
identifying in one of the CECPs, current aspect information (CAI) for a current aspect presented in the CECP;
searching the content source to identify PEC which include prior presentations of the current aspect;
identifying in the PEC, prior aspect information (PAI) that relates to the CAI for the current aspect presented in the CECP;
comparing the CAI to the PAI to identify relations between the CAI and the PAI;
generating, based on a result of the comparing, related content link data (RCLD) for the PAI that has been identified as being related to the CAI;
generating expanded content data (ECD) by embedding, in the CEC, a link to the PAI identified in the RCLD; and
storing the ECD.

11. The computer readable medium of claim 10,
wherein the link in the ECD is selectable by the user during a presentation of the ECD to the user; and
wherein upon selection of the link, a presentation of the CEC includes a presentation of the PEC identified in the RCLD.

12. The computer readable medium of claim 11,
wherein during the presentation of the ECD, the presentation of the CEC occurs in a first presentation window and the PEC identified in the RCLD occurs in a sidebar presentation window.

13. The computer readable medium of claim 12,
wherein the operations occur automatically.

14. A process for training an artificial intelligence/machine learning (AI/ML) configured server episode relations engine (SERE) to identify at least one relationship between a current episode content (CEC) and a prior episode content (PEC), wherein the CEC and the PEC are each an episode of a digital content series provided by a content source, comprising:
identifying, from “X” instances of digital content provided in “Y” episodes of the digital content series, “Z” portions of digital content;
wherein X, Y and Z are integers;
generating an initial data set populated by related data obtained for two or more of the Z portions of digital content; and
applying a linear regression analysis to the related data in the initial data set to generate a first reduced data set;
wherein the linear regression analysis identifies, based on the related data, relations between content provided for each of a first portion of the Z portions of digital content with content provided in each of the other portions of the Z portions of the digital content; and
generating related content link data (RCLD) based on results obtained from the linear regression analysis; and
wherein the RCLD, when embedded into expanded content data (ECD), includes a first instance of the X instances of the digital content series and a link to a second portion of the X instances of the digital content series.

15. The process of claim 14,
wherein the related data is obtained from the content source.

16. The process of claim 14,
wherein the related data includes at least one of metadata and audio data.

17. The process of claim 14, further comprising:
applying a polynomial regression analysis to the related data in the initial data set to generate a second reduced data set;
wherein the polynomial regression analysis further identifies, based on the related data, relations between content provided for each of a first portion of the Z portions of digital content with content provided in each of the other portions of the Z portions of the digital content; and
wherein the generating related content link data is further based on results obtained from the polynomial regression analysis.

18. The process of claim 17, further comprising:
receiving user feedback;
wherein the user feedback concerns a utilization of the RCLD, as presented to a user of a user device configured to receive and present the ECD to the user;
identifying a portion of the Z portions of digital content to which the user feedback pertains;
identifying the RCLD presented to the user with respect to which the user feedback pertains;
determining if the user feedback is a LIKED; and
when the user feedback is LIKED,
increasing a weighting of the RCLD with respect to the portion of the Z portions of digital content.

19. The process of claim 18, further comprising:
determining if the user feedback is a DISLIKED; and
when the user feedback is DISLIKED,
decreasing the weighting of the RCLD with respect to the portion of the Z portions of digital content.

20. The process of claim 19, further comprising:
performing a regression analysis on the user feedback to determine if the user feedback is LIKED or DISLIKED.
